(19) United States
(12) Patent Application Publication
(10) Pub. No.: US 2026/0129393 A1
(43) Pub. Date: May 7, 2026

(54) COMPUTER-IMPLEMENTED SOUND CALIBRATION METHOD, SYSTEM AND STORAGE MEDIUM

(71) Applicant: LINKPLAY TECHNOLOGY INC. NANJING, Nanjing (CN)

(72) Inventors: Dongsheng LIAO, Nanjing (CN); Jiaxin LI, Nanjing (CN); Pu YANG, Nanjing (CN); Lifeng ZHAO, Nanjing (CN); Qi WANG, Nanjing (CN)

(73) Assignee: LINKPLAY TECHNOLOGY INC. NANJING, Nanjing (CN)

(21) Appl. No.: 19/313,884

(22) Filed: Aug. 29, 2025

Related U.S. Application Data
(63) Continuation of application No. PCT/CN2025/080418, filed on Mar. 4, 2025.

(30) Foreign Application Priority Data
Nov. 1, 2024 (CN) 202411552373.X

(51) Int. Cl. H04S 7/00

(52) U.S. Cl. CPC H04S 7/301; H04S 2400/11; H04S 2400/13; H04S 2420/07

(57) ABSTRACT

A computer-implemented sound calibration method, a system and a storage medium are provided. A test audio is played by a subwoofer and a main speaker, transmitted audio is collected by an audio collection device at a primary listening position, a sound generation delay and a volume parameter difference are analyzed, and the subwoofer is calibrated based on of a frequency response curve of a scenario, so as to solve the problem in the related art where the user experience is adversely affected due to low sound calibration accuracy between the subwoofer and the main speaker.

### CROSS-REFERENCE TO THE RELATED APPLICATIONS

This application is a continuation application of International Application No. PCT/CN2025/080418, filed on Mar. 4, 2025, which is based upon and claims priority to Chinese Patent Application No. 202411552373.X, filed on Nov. 1, 2024, the entire contents of which are incorporated herein by reference.

### TECHNICAL FIELD

The present disclosure relates to the field of audio processing technology, in particular to a computer-implemented sound calibration method, a system and a storage medium.

### BACKGROUND

In a home cinema and a High Fidelity (HiFi) audio system, a subwoofer is a device for low-frequency reproduction, and it plays a very important role in the overall sound quality. Usually, the subwoofer is separated from a main speaker, so it is necessary to perform balance calibration between them.

In the related art, a propagation delay of an audio signal between the subwoofer and the main speaker is calibrated so as to achieve the audio synchronization. The balance calibration of sound quality and volume is performed manually. In other words, for an existing balance calibration mode, such factors as an acoustic characteristic of an environment are not taken into consideration, so the calibration is inaccurate.

### SUMMARY

In a first aspect, the present disclosure provides in some embodiments a computer-implemented sound calibration method. An audio playback system at least includes a subwoofer, a main speaker and an audio collection device. The computer-implemented sound calibration method includes: detecting connection states of the subwoofer and the main speaker and an operating state of the audio collection device, and determining whether the connection states and the operating state are normal; in a case that the connection states and the operating state are normal, testing an acoustic characteristic of a scenario where the audio playback system is located and a delay at a primary listening position using a first test audio to obtain a frequency response curve and a propagation delay of the scenario, the propagation delay being a time difference between propagation of the first test audio from the subwoofer to the primary listening position and propagation of the first test audio from the main speaker to the primary listening position; controlling the subwoofer and the main speaker to play a second test audio, collecting transmitted audio at the primary listening position through the audio collection device, and calculating a sound generation delay between the subwoofer and the main speaker using a cross correlation method; calculating a volume parameter difference of the subwoofer relative to the main speaker based on the transmitted audio of the subwoofer and the transmitted audio of the main speaker; and calibrating a device parameter of the subwoofer based on the sound generation delay, the volume parameter difference and the frequency response curve.

In a second aspect, the present disclosure provides in some embodiments an audio playback system at least including a subwoofer, a main speaker, an audio collection device, a memory and at least one processor. The memory is configured to store therein an instruction. The at least one processor is configured to call the instruction in the memory to implement the above-mentioned computer-implemented sound calibration method.

In a third aspect, the present disclosure provides in some embodiments a computer-readable storage medium storing therein a computer-executable instruction. The computer-executable instruction is called and executed by a processor to implement the above-mentioned computer-implemented sound calibration method.

The other features and advantages will be described hereinafter, and may become apparent or understandable partially from the embodiments of the present disclosure. The objects and the other advantages of the present disclosure may be implemented and obtained through structures specified in the description, claims and drawings.

In order to make the objects, the features and the advantages of the present disclosure more apparent, the present disclosure will be described hereinafter in a clear and complete manner in conjunction with the drawings and embodiments.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic view showing an audio playback system according to an embodiment of the present disclosure;

FIG. 2 is a flow chart of a computer-implemented sound calibration method according to an embodiment of the present disclosure; and

FIG. 3 is another flow chart of the computer-implemented sound calibration method according to an embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such words as “first”, “second”, “third” and “fourth” (if exists) involved in the specification and the appended claims are merely used to differentiate different objects rather than to represent any specific order. It should be appreciated that, the data used in this way may be replaced with each other, so as to implement the embodiments in an order other than that shown in the drawings or described in the specification. In addition, such terms as “include” or “including” or any other variations involved in the present disclosure intend to provide non-exclusive coverage, so that a procedure, method, system, product or device including a series of steps or units may also include any other elements not listed herein, or may include any inherent steps or units of the procedure, method, system, product or device.

An audio playback system in the embodiments of the present disclosure will be described hereinafter in details from the perspective of hardware processing.

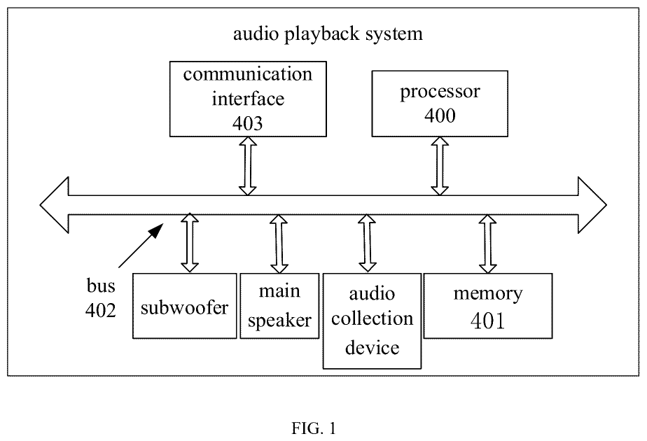

Referring to FIG. 1, the audio playback system includes a subwoofer, a main speaker, an audio collection device, a processor 400 and a memory 401. The memory 401 is configured to store therein a computer-executable instruction executed by the processor 400, and the processor 400 is configured to execute the computer-executable instruction to implement a computer-implement sound calibration method.

The audio playback system in FIG. 1 further includes a bus 402 and a communication interface 403, and the processor 400, the communication interface 403 and the memory 401 are coupled to each other via the bus 402.

The memory 401 includes a high-speed Random Access Memory (RAM), or a non-volatile memory, e.g., at least one magnetic disk memory. A system network element is in communication with at least one other network element through at least one communication interface 403 (wired or wireless), e.g., Internet, wide area network, local network, or metropolitan area network. The bus 402 is an Industry Standard Architecture (ISA) bus, a Peripheral Component Interconnect (PCI) bus or an Extended Industry Standard Architecture (EISA) bus. The bus includes an address bus, a data bus, a control bus, etc. For ease of description, the bus is represented by merely one double sided arrow, but it does not mean that there is merely one bus or one type of buses.

The processor 400 may be an Integrated Circuit (IC) having a signal processing capability. During the implementation, steps of the method may be completed through an integrated logic circuit of hardware in the processor 400 or instructions in the form of software. The processor 400 may be a general-purpose processor, e.g., Central Processing Unit (CPU) or Network Processor (NP), a Digital Signal Processor (DSP), an Application-Specific Integrated Circuit (ASIC), a Field Programmable Gate Array (FPGA) or any other programmable logic element, a discrete gate or transistor logic element, or a discrete hardware assembly, which may be used to implement or execute the methods, steps or logic diagrams in the embodiments of the present disclosure. The general-purpose processor may be a microprocessor or any other conventional processor. The steps of the method in the embodiments of the present disclosure may be directly implemented by the processor in the form of hardware, or a combination of hardware and software modules in the processor. The software module may be located in a known storage medium such as an RAM, a flash memory, a Read Only Memory (ROM), a Programmable ROM (PROM), an Electrically Erasable Programmable ROM (EEPROM), or a register. The storage medium may be located in the memory 401, and the processor 400 may read information stored in the memory 401 so as to implement the steps of the method in conjunction with the hardware.

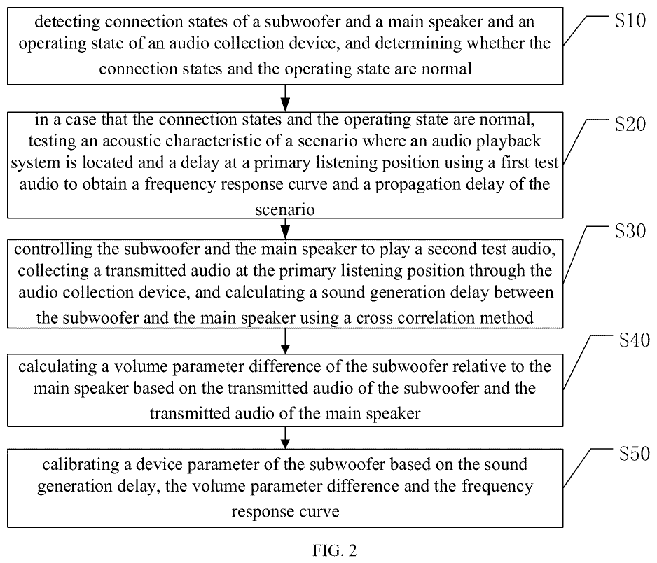

For ease of understanding, a specific procedure in the embodiments of the present disclosure will be described hereinafter. Referring to FIG. 2, the present disclosure provides in some embodiments a computer-implemented sound calibration method, which is applied to an audio playback system at least including a subwoofer, a main speaker and an audio collection device. The computer-implemented sound calibration method includes the following steps.

Step S10: detecting connection states of the subwoofer and the main speaker and an operating state of the audio collection device, and determining whether the connection states and the operating state are normal.

The computer-implemented sound calibration method in the embodiments of the present disclosure is triggered and executed by a terminal. The terminal includes a graphical user interface provided with trigger controls for a sound collection instruction and a communication test instruction. A user operates the trigger control to trigger the communication test instruction. In response to the instruction, the terminal detects communication links of the subwoofer and the main speaker and sends a test signal, so as to determine whether the audio collection device is capable of collecting information.

Identically, the user operates the trigger control to trigger the sound collection instruction. In response to the sound collection instruction, the terminal starts to play at least one kind of test signal, and collects an ambient sound, so as to collect audios at different positions in an environment where the audio collection system is located.

In the embodiments of the present disclosure, the connection states of the subwoofer and the main speaker are detected through signal voltage detection and audio signal detection. For the signal voltage detection, to be specific, a voltage at an input port of each of the subwoofer and the main speaker is read periodically through a program, and a voltage threshold range (e.g., 1 V to 10 V) is set. In a case that the voltage at the input port is within the voltage threshold range and an audio signal is outputted, the connection state is determined as normal.

For the audio signal detection, to be specific, a frequency and an intensity of the audio signal are detected using an analog signal collection module. In a case that the frequency is within a predetermined range (e.g., 20 Hz to 20 kHz), the connection state is determined as normal.

The operating state of the audio collection device is detected through input signal intensity detection or frequency response detection. For the input signal intensity detection, to be specific, an intensity of an input signal of the audio collection device is read by an analog-to-digital converter (ADC), and whether the input signal is within a normal range is determined based on an appropriate intensity threshold.

For the frequency response detection, to be specific, frequency components of the input signal are analyzed using a Fast Fourier Transform (FFT) algorithm, and the input signal has a frequency within a range of 20 Hz to 20 kHz, so as to determine whether the audio collection device operates normally.

Step S20: in a case that the connection states and the operating state are normal, testing an acoustic characteristic of a scenario where the audio playback system is located and a delay at a primary listening position using a first test audio to obtain a frequency response curve and a propagation delay of the scenario.

The propagation delay is a time difference between propagation of the first test audio from the subwoofer to the primary listening position and propagation of the first test audio from the main speaker to the primary listening position. This step mainly relates to self-test of the subwoofer, the main speaker and the audio collection device in the audio playback system, so as to determine audio response parameters thereof, i.e., the frequency response curve and the propagation delay. The frequency response curve refers to a curve of losses caused by a current environment on the sound, e.g., acoustic reflection and refraction, or a delay curve. The subsequent volume calibration is performed based on the curve, and the curve is used to extract acoustic characteristics of the current scenario.

To be specific, a wide-band test signal (e.g., a logarithmic sweep signal or a Maximum Length Sequence (MLS) signal) is sent, and a response in a room is collected by a microphone. The collected signal is analyzed using an FFT algorithm to obtain a frequency response curve for the room. The audio collection device is placed at the primary listening position, a difference between arrival times of the sounds from different speakers is determined, and a position of a listener relative to each speaker is calculated based on the difference between the arrival times. The difference between the arrival times is just the propagation delay between a sound source and the primary listening position. To be specific, the propagation delay is calculated through a cross correlation method.

Step S30: controlling the subwoofer and the main speaker to play a second test audio, collecting transmitted audio at the primary listening position through the audio collection device, and calculating a sound generation delay between the subwoofer and the main speaker using a cross correlation method.

In a possible embodiment of the present disclosure, a control on a user interface is triggered to control the subwoofer and the main speaker to generate a sound, and the audio collection device (e.g., microphone) at the primary listening position collects an audio, and then the sound generation delay is calculated using the cross correlation method.

To be specific, the main speaker and the subwoofer of the audio playback system are powered on, and the audio signal is collected by the microphone. The arrival times of the audio signals are calculated using the cross correlation method: R_ms(τ)=Σ[m(n)s(n+τ)], and τ_ms=argmax (R_ms(τ)), where m (n) represents the audio signal generated by the main speaker, s(n) represents the audio signal generated by the subwoofer, and τ_ms represents the sound generation delay between the main speaker and the subwoofer.

There is a difference between the primary listening position in Step S30 and the primary listening position in Step S20. The primary listening position in Step S30 refers to a surface of each of the subwoofer and the main speaker, or a position of a sound-exiting opening thereof. In this way, merely a signal processing delay of the device itself, not including the propagation delay, is calculated.

In another possible embodiment of the present disclosure, the subwoofer and the main speaker are tested sequentially or concurrently. In a case that the subwoofer and the main speaker are tested sequentially, a same second test audio is used. In a case that the subwoofer and the main speaker are test concurrently, sound signals with different frequencies or frequency bands are generated based on the second test audio, and then played by the subwoofer and the main speaker. To be specific, the sound generation delay may also be calculated using the cross correlation method.

Step S40: calculating a volume parameter difference of the subwoofer relative to the main speaker based on the transmitted audio of the subwoofer and the transmitted audio of the main speaker.

The volume parameter difference is a sound pressure difference between the subwoofer and the main speaker. Spectra of the transmitted audios of the subwoofer and the main speaker are analyzed to extract frequency information and amplitude information, a corresponding sound pressure is calculated based on the frequency information and the amplitude information, and then the sound pressure difference between the subwoofer and the main speaker is calculated to obtain the volume parameter difference.

In the embodiments of the present disclosure, the spectrum of the transmitted audio is analyzed using the FFT algorithm to obtain an audio amplitude curve of the subwoofer and an audio amplitude curve of the main speaker, a standard deviation between the two curves is calculated to obtain an amplitude difference, and then the volume parameter difference is calculated based on a relational function of the sound pressure, the amplitude and a device parameter.

Step S50: calibrating a device parameter of the subwoofer based on the sound generation delay, the volume parameter difference and the frequency response curve.

The calibration includes two steps independent of each other, i.e., delay calibration and volume calibration. The delay calibration is performed based on the sound generation delay. In a case that there is the propagation delay, the delay calibration further needs to be performed in combination with the propagation delay. To be specific, a delay situation between the subwoofer and the main speaker is determined based on the sound generation delay, e.g., a sound is generated by the subwoofer before or after the main speaker. A time adjustment direction is determined based on the delay situation, and then time compensation is performed on the subwoofer based on the time adjustment direction in combination with the propagation delay. It should be appreciated that, a duration of the audio generated by the subwoofer or a time when the subwoofer is triggered is adjusted, and whatever it is, actually a corresponding audio generation program is created to obtain a sound generation program of the subwoofer.

According to the computer-implemented sound calibration method in the embodiments of the present disclosure, the subwoofer and the main speaker are controlled to play a test audio, and the transmitted audio at the primary listening position is collected by the audio collection device, the sound generation delay and the volume parameter difference are calculated, and then the subwoofer is calibrated based on the frequency response curve of the scenario. As a result, it is able to solve the problem in the related art where the user experience is adversely affected due to low sound calibration accuracy between the subwoofer and the main speaker.

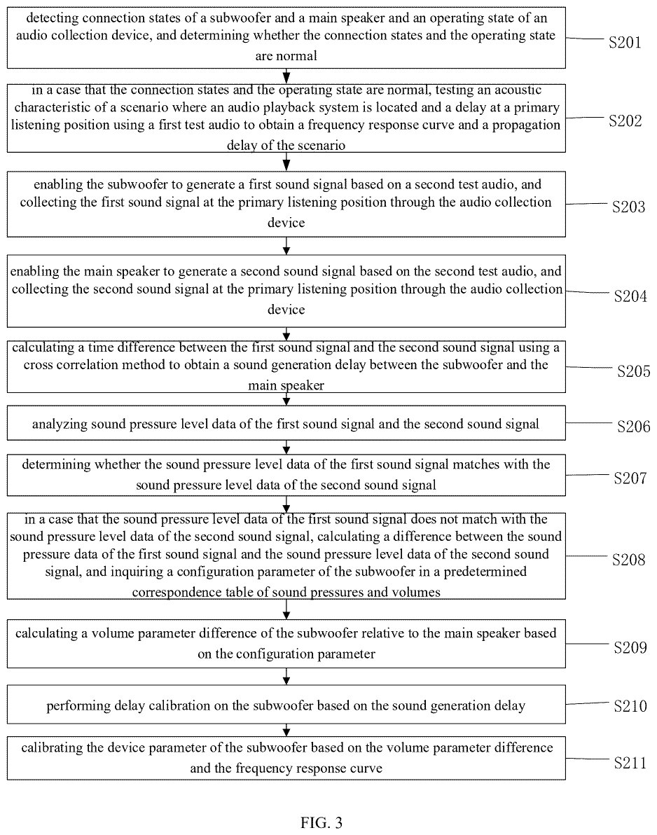

Referring to FIG. 3, the present disclosure provides in some embodiments another computer-implemented sound calibration method, which includes the following steps.

Step S201: detecting connection states of a subwoofer and a main speaker and an operating state of an audio collection device, and determining whether the connection states and the operating state are normal.

Step S202: in a case that the connection states and the operating state are normal, testing an acoustic characteristic of a scenario where an audio playback system is located and a delay at a primary listening position using a first test audio to obtain a frequency response curve and a propagation delay of the scenario.

In a possible embodiment of the present disclosure, the first test audio is played at a position where the subwoofer is located and a position where the main speaker is located, and a test audio is collected by the audio collection device at the primary listening position in the scenario. A time difference between propagation of the first test audio from the subwoofer to the primary listening position and propagation of the first test audio from the main speaker to the primary listening position is calculated based on a receiving time of the test audio and a sending time of the first test audio, to obtain a propagation time difference. Spectra of the test audio and the first test audio are analyzed through an FFT algorithm, and a corresponding frequency response is calculated based on the analyzed spectra to obtain the frequency response curve of the scenario.

To be specific, the frequency response is calculated through H (f)=Y (f)/X (f), where Y (f) represents a spectrum of a signal collected by a microphone, and X (f) represents a spectrum of a test signal.

The analyzing the spectra of the test audio and the first test audio through the fast Fourier transform algorithm and calculating the corresponding frequency response based on the analyzed spectra to obtain the frequency response curve of the scenario includes: performing denoising processing on the test audio and the first test audio, so as to remove background noises; performing segmentation on the denoised test audio and the denoised first test audio to obtain a plurality of signal segments; performing FFT on each signal segment, converting a time-domain signal into a frequency-domain signal to obtain an FFT result corresponding to each of the test audio and the first test audio, and extracting frequency information and amplitude information in the FFT result; and calculating the frequency response curve of the scenario based on the frequency information and the amplitude information. The frequency response curve represents a relationship between amplitude response and frequency.

This step is used to initialize components of the audio playback system. At first, the connection states of the subwoofer and the main speaker and the operating state of the audio collection device are initialized, so that they are each in a normal state. In a case that a detection result is abnormal after the initialization, a user is prompted to determine and process an abnormal state. Otherwise, the test is continued to collect relevant parameters of an environment, e.g., acoustic reflection and acoustic refraction, and a propagation delay of the audio at each position in the environment.

To be specific, a wide-band test signal (e.g., a logarithmic sweep signal or an MLS signal) is sent, and a response in the scenario (e.g., room) is collected by the audio collection device. The collected signal is analyzed using an FFT algorithm to obtain a frequency response curve for the room. The frequency response curve includes a plurality of frequency responses, and each frequency response is calculated through the above-mentioned equation.

Further, the user is prompted to place the audio collection device at the main listening position. Through calculating a difference between sound arrival times of different speakers (i.e., the propagation delay), a position of a listener relative to each speaker is determined. Here, the propagation delay is calculated using a cross correlation method: Rxy(τ)=Σ[x(n)y(n+τ)], and τ_max=argmax(Rxy(τ)), where x(n) and y(n) represent test signals generated by the subwoofer and the main speaker respectively, and τ_max represents a delay between the test signals.

Step S203: enabling the subwoofer to generate a first sound signal based on a second test audio, and collecting the first sound signal at the primary listening position through the audio collection device.

Step S204: enabling the main speaker to generate a second sound signal based on the second test audio, and collecting the second sound signal at the primary listening position through the audio collection device.

In Steps S203 and S204, the subwoofer and the main speaker are tested concurrently. To be specific, a test signal (e.g., a pulse signal) is generated by a signal generator and sent to the main speaker, and parameters of the signal generator (e.g., frequency and amplitude) need to meet experimental requirements. A test signal is generated by the signal generator and sent to the subwoofer, and this signal should be in synchronization with the signal sent to the main speaker, but it has a frequency range different from the signal sent to the main speaker so as to cover a low-frequency range. Further, the sound signals sent by the main speaker and the subwoofer are collected by the audio collection device at the primary listening position, and the collected sound signals are subject to denoising and demeaning, so as to improve the analysis accuracy. In addition, a window function is used for the sound signals to reduce spectrum leakage and a boundary effect. Finally, cross correlation is performed on the sound signal generated by the main speaker and the sound signal generated by the subwoofer to obtain a cross correlation function, and then the sound generation delay is calculated based on the cross correlation function.

Step S205: calculating a time difference between the first sound signal and the second sound signal using the cross correlation method to obtain the sound generation delay between the subwoofer and the main speaker.

In a possible embodiment of the present disclosure, the first sound signal and the second sound signal are subjected to denoising and demeaning. A window function is used for the processed sound signals. A cross correlation function of the sound signals is calculated through Fourier transform, and a cross correlation function is obtained through inverse fast Fourier transform (IFFT). Then, a peak position is extracted from the cross correlation function, and a difference between arrival times of the sound signals is calculated to obtain the sound generation delay between the subwoofer and the main speaker.

To be specific, the cross correlation is performed as follows.
Step 1: Fourier transform is performed on the sound signal generated by each of the main speaker and the subwoofer to obtain a spectrum of the sound signal.
Step 2: a cross correlation function of the two sound signals is calculated through FFT:

$${R}_{xy} ( τ ) = {\int }_{⋯∞}^{∞} x ( t ) \cdot y ( t + τ ) dt ,$$

where x(t) and y(t) represent the sound signals generated by the main speaker and the subwoofer respectively, and τ represents the delay.
Step 3: a cross correlation function is calculated through FFT: R_{xy}(τ)=IFFT(FFT(x(t))·FFT(y(t))*), where x(t) and y(t) represent the sound signals generated by the main speaker and the subwoofer respectively, τ represents the sound generation delay, FFT represents fast Fourier transform, IFFT represents inverse fast Fourier transform, and * represents complex conjugate.

Step S206: analyzing sound pressure level data of the first sound signal and the second sound signal.

Step S207: determining whether the sound pressure level data of the first sound signal matches with the sound pressure level data of the second sound signal.

Step S208: in a case that the sound pressure level data of the first sound signal does not match with the sound pressure level data of the second sound signal, calculating a difference between the sound pressure level data of the first sound signal and the sound pressure level data of the second sound signal, and inquiring a configuration parameter of the subwoofer in a predetermined correspondence table of sound pressures and volumes.

Step S209: calculating the volume parameter difference of the subwoofer relative to the main speaker based on the configuration parameter.

In actual use, in a case that the main speaker is controlled to generate the second sound signal, a reference sound pressure level (85 dB SPL) is set for the second sound signal, a pink noise signal is used to create the second sound signal for test, and the sound pressure level data of the second sound signal is collected by the audio collection device. In addition, the sound pressure level data of the first sound signal is collected in real time, and then the difference between the first sound signal and the second sound signal is determined.

Step S210: performing delay calibration on the subwoofer based on the sound generation delay.

In a possible embodiment of the present disclosure, this step includes: determining whether the propagation delay is greater than a predetermined delay threshold; performing compensation processing on a sound generation time of the subwoofer using the sound generation delay or both the propagation delay and the sound generation delay based on a determination result; and calculating a compensation device parameter of the subwoofer based on the volume parameter difference and the frequency response curve, and performing calibration based on the compensation device parameter.

The performing the compensation processing on the sound generation time of the subwoofer using the sound generation delay or both the propagation delay and the sound generation delay based on the determination result includes: determining whether the sound generation delay is greater than zero; in a case that the propagation delay is greater than the predetermined delay threshold and the sound generation delay is greater than zero, performing delay processing on the subwoofer based on the propagation delay and the sound generation delay; in a case that the propagation delay is greater than the predetermined delay threshold and the sound generation delay is smaller than zero, performing advancing processing on the subwoofer based on the propagation delay and the sound generation delay; in a case that the propagation delay is smaller than the predetermined delay threshold and the sound generation delay is greater than zero, performing delay processing on the subwoofer based on the sound generation delay; and in a case that the propagation delay is smaller than the predetermined delay threshold and the sound generation delay is smaller than zero, performing advancing processing on the subwoofer based on the sound generation delay.

The performing the compensation processing on the sound generation time of the subwoofer using the sound generation delay or both the propagation delay and the sound generation delay based on the determination result further includes: analyzing phase responses of the main speaker and the subwoofer in the vicinity of a crossover frequency based on the transmitted audio; and calculating a difference between the phase responses of the main speaker and the subwoofer, and delaying the sound generation time of the subwoofer by a predetermined fine-tuning value based on the difference, so that the subwoofer and the main speaker have a same phase within a same frequency range.

Step S211: calibrating the device parameter of the subwoofer based on the volume parameter difference and the frequency response curve.

In a possible embodiment of the present disclosure, this step includes: calculating an audio gain of the subwoofer using a bisection method based on the volume parameter difference; fitting the frequency response curve with the transmitted audio of the subwoofer using a least square method, to obtain an actual frequency response of the subwoofer; and calculating a compensation device parameter of the subwoofer based on the audio gain and the actual frequency response, and performing the calibration.

Here, the volume calibration includes setting a reference level of the main speaker (i.e., setting the sound pressure level data of the second sound signal), level matching of the subwoofer, and smoothing of the frequency response curve.

During the setting of the reference level of the main speaker, at first a reference sound pressure level (usually 85 dB SPL) is set for the main speaker, a pink noise signal is used for the test, and then the sound pressure level data is collected by the microphone.

During the level matching of the subwoofer, a gain of the subwoofer is adjusted gradually so that its sound pressure level matches with the sound pressure level of the main speaker in the vicinity of the crossover frequency. Here, an appropriate gain is rapidly calculated using a bisection method: gain_sub=binary_search (gain_min, gain_max, tolerance), where binary_search represents a binary search function, gain_min and gain_max represent a gain search range, and tolerance represents an allowed error range.

During the smoothing of the frequency response curve, in order to enable a low-frequency response to be smoother, the frequency response of the subwoofer is fine-tuned using a parametric equalizer (PEQ). Here, a target curve is fitted using the least square method: H_target(f)=a_0+a_1f+a_2f\hat{ }2+ . . . +a_nf\hat{ }n, and [a_0, a_1, . . . , a_n]=argmin(Σ[H_measured(f)−H_target(f)]\hat{ }2). The audio playback system automatically sets a PEQ parameter based on a fitting result, so as to calculate an actual frequency response.

In another possible embodiment of the present disclosure, subsequent to calibrating the device parameter of the subwoofer based on the sound generation delay, the volume parameter difference and the frequency response curve, the computer-implemented sound calibration method further includes: adjusting the audio collection device to a plurality of secondary listening positions, and calculating a corresponding sound generation delay and a corresponding volume parameter difference, i.e., obtaining groups of delay and volume calibration data {(delay_1, gain_1), (delay_2, gain_2), . . . , (delay_n, gain_n)}; and fusing the sound generation delay and the volume parameter difference at each secondary listening position using a weighted mean method to obtain a fused compensation parameter, and calibrating the subwoofer.

The scenario where the system is located is actually a space with a certain area, and the user receives the sound at different positions. In order to provide a same sound effect at each position, the calibration is performed at a plurality of positions through the following steps.
Step 1: the microphone is placed at different listening positionings so as to measure the delays and the gains of the subwoofer, i.e., the delay calibration and the volume calibration are performed at each position.
Step 2: the calibration data obtained at different listening positions are processed using a weighted mean method, and a weight value is set based on a distance between the secondary listening position and the primary listening positioning, so as to optimize the overall delay and gain of the subwoofer. The weight value is calculated through delay_opt=Σ(w_i*delay_i)/Σw_i, and gain_opt=Σ(w_i*gain_i)/Σw_i, where w_i represents a weight value at an i^{th} secondary listening position.
Step 3: a standard deviation of the frequency response curves at the positions is calculated, so as to evaluate a spatial equalization degree of the entire scenario, and optimize the sound distribution of the subwoofer.

Further, the fusing the sound generation delay and the volume parameter difference at the secondary listening position using the weighted mean method to obtain the fused compensation parameter, and calibrating the subwoofer includes: measuring a distance between each secondary listening position and the primary listening position, and assigning a corresponding weight value to the distance using a weighted mean method; and fusing the sound generation delay and the volume parameter difference at each secondary listening position based on the weight value to obtain the fused compensation parameter, and calibrating the subwoofer.

Subsequent to measuring the distance between the secondary listening position and the primary listening position, the computer-implemented sound calibration method further includes: obtaining a frequency response curve at each secondary listening position, and calculating a standard deviation of the secondary listening position and the primary listening position; and determining a spatial equalization degree of the scenario based on the standard deviation. The standard deviation is calculated through σ(f)=sqrt(Σ[H_i(f)−H_avg(f)]\hat{ }2/N), where H_i(f) represents a frequency response at the i^{th} secondary listening position, H_avg(f) represents an average frequency response, and N represents the quantity of the secondary listening positions.

The assigning the corresponding weight value to the distance using a weighted mean method includes: calculating a weight value at each secondary listening position using the weighted mean method based on the spatial equalization degree and the distance.

In actual use, the sound effect, especially the frequency response curve and the propagation delay, may change along with a change in the scenario, e.g., the layout, the devices and the objects in the scenario, so the subwoofer may not synchronize with the main speaker again. Hence, the present disclosure further provides in some embodiments an adaptive optimization step, which includes: continuously monitoring, by the audio playback system, an audio playback situation, e.g., an ambient noise level, a volume change and different types of audio contents; training a machine learning model based on data obtained through monitoring, the model being used to predict optimal calibration parameters of the subwoofer in different scenarios; and dynamically adjusting, by the audio playback system, the delay and the gain of the subwoofer based on a prediction result of the machine leaning model. In this way, the subwoofer is adapted to different environments and different audio contents, so as to improve the user experience. The collected data is used to train the machine learning model, e.g., a Support Vector Machine (SVM) or neural network, so as to predict the optimal calibration parameter in different scenarios: [delay_pred, gain_pred]=ML_model (audio_type, volume, noise_level, . . . ).

Further, a plurality of subwoofers may be provided in the scenario, so collaborative calibration is further performed on the subwoofers, which includes: measuring a delay and a gain of each subwoofer, with a mutual influence among the subwoofers being taken into consideration; optimizing relative delays and gains of the subwoofers based on a measurement result, so that the sounds generated by the subwoofers are fused; and automatically adjusting a crossover frequency, i.e., analyzing the frequency response curves of the main speaker and the subwoofers, and automatically selecting an optimal crossover frequency.

The phase response at the crossover frequency may be adjusted automatically. To be specific, frequency response data of the main speaker and the subwoofer is tested to determine a frequency at which a low-frequency response of the main speaker starts to attenuate and a flat interval of a low-frequency response of the subwoofer, and then optimal crossover frequencies of the main speaker and the subwoofer are determined automatically. The crossover frequency is determined based on the superposition of the frequency responses, so as to ensure smooth transition of the low-frequency response. The crossover frequency is calculated through f_crossover=find_optimal_crossover (H_main(f), H_sub(f)), where find_optimal_crossover is a heuristic algorithm for finding a crossover frequency at which the low-frequency response of the main speaker starts to attenuate and a response of the subwoofer is flat.

In another possible embodiment of the present disclosure, the calibration may be performed within a range. To be specific, during the adaptive optimization, a dynamic range of the audio content played by each of the subwoofer and the main speaker is monitored, and the dynamic range includes a difference between a minimum value and a maximum value of the volume. Then, a compression ratio and a compression threshold of the subwoofer are adjusted automatically based on the dynamic range, so as to prevent the occurrence of overload in a case of output at a high volume, and ensure the stability and the sound quantity in a case of output at a low volume.

After the calibration, parameter optimization is further performed based on feedback data on the user interface. To be specific, scores about the calibration and opinions from the user are collected via the user interface, and the feedback data is used for updating the machine learning model, so as to further optimize the calibration parameters of the subwoofer.

In another possible embodiment of the present disclosure, for ease of calibration, a user-friendly interface is further provided, so as to guide the user to complete an initial calibration procedure. On the interface, an animation or pattern is provided to indicate a location where the microphone is to be placed and a progress of the calibration. In addition, a one-key automatic calibration function is provided, and a manual adjustment function is reserved for fine-tuning.

The user interface further includes a scenario presetting function. Sound settings in different scenarios, such as movie, music and game, are provided for rapid selection by the user, and a corresponding calibration parameter of the subwoofer is automatically loaded by the audio playback system based on the selected scenario.

In another possible embodiment of the present disclosure, in a case that the subwoofer, the main speaker and the audio collection device are detected, self-test is periodically performed on hardware and software of the audio playback system, so that the subwoofer, the main speaker and the other device operate normally. A self-test report is generated, and in a case that an abnormality occurs, the user is prompted to maintain the system or perform re-calibration.

During the calibration, the frequency response curve or the calibration parameter is detected in real time. The system automatically identifies the abnormality, and sends an alert or automatically calibrates the device parameters.

A firmware updating mechanism is further provided for the subwoofer and the main speaker of the audio playback system. The firmware updating mechanism includes: periodically detecting whether there is a new firmware version, the firmware version including algorithm improvements and function enhancements; and preventing unexpected interruption during the updating, and ensuring that the system operates normally after the updating.

According to the computer-implemented sound calibration method in the embodiments of the present disclosure, it is able to achieve the optimization at a low frequency in a comprehensive and accurate manner through the delay calibration and the volume calibration. At first, the system is initialized and the environment is detected, so as to analyze the acoustic characteristics of the room and the listener's position. Next, the synchronization of the subwoofer and the main speaker is achieved through calculating the delay and optimizing the phase alignment. During the volume calibration, the level matching is performed rapidly using the bisection method, and the frequency response is smoothed using the parametric equalizer. In the multiple-positions optimization technology, data about the plurality of positions is combined using the weighted mean method, so as to significantly increase the spatial equalization degree. It should be appreciated that, the adaptive optimization mechanism based on machine learning is introduced, so as to dynamically adjust the parameters based on different audio contents and the ambient noise, thereby to continuously improve the user experience. In addition, such advanced functions as collaborative calibration of the subwoofers and automatic crossover adjustment are further provided, so as to further improve the flexibility and the adaptability of the system. The calibration is performed easily through the user-friendly interface, and the professional calibration may also be performed. Finally, through the abnormality detection and the self-test, it is able to ensure the long-term stability and reliability of the system. In a word, through the comprehensive, smart and self-adaptive calibration method, it is able to solve the problems in the related art, and improve the user experience at a low frequency, so the calibration method may be applied to the home cinema and the HiFi audio system.

The present disclosure further provides in some embodiments a computer-readable storage medium. The computer-readable storage medium is a non-volatile computer-readable storage medium, or a volatile computer-readable storage medium. The computer-readable storage medium stores therein an instruction, and the instruction is executed by a computer so as to implement the above-mentioned sound calibration method.

The present disclosure further provides in some embodiments a computer program product, which includes a computer-readable storage medium storing therein a program code. An instruction included in the program code is executed to implement the above-mentioned sound calibration method. The implementation of the computer program product may refer to that of the sound calibration method, and thus will not be particularly defined herein.

It should be appreciated that, for convenience and clarification, operation procedures of the system and device described hereinabove may refer to the corresponding procedures in the method embodiments, and thus will not be particularly defined herein.

Unless otherwise specified, such words as “install”, “arrange” and “connect” may have a general meaning, e.g., the word “connect” may refer to fixed connection, removable connection or integral connection, or mechanical or electrical connection, or direct connection or indirect connection via an intermediate component, or communication between two components. The meanings of these words may be understood by a person skilled in the art according to the practical need.

In a case that the functional units are implemented in a software form and sold or used as a separate product, they may be stored in a computer-readable storage medium. Based on this, the technical solutions of the present disclosure, partial or full, or parts of the technical solutions of the present disclosure contributing to the related art, may appear in the form of software products, which may be stored in a storage medium and include several instructions so as to enable a computer device (a personal computer, a server or a network device) to execute all or parts of the steps of the method in the embodiments of the present disclosure. The storage medium includes any medium capable of storing therein program codes, e.g., a Universal Serial Bus (USB) flash disk, a mobile hard disk, a Read-Only Memory (ROM), a Random Access Memory (RAM), a magnetic disk or an optical disk.

In the embodiments of the present disclosure, it should be appreciated that, such words as “in the middle of”, “on/above”, “under/below”, “left”, “right”, “vertical”, “horizontal”, “inside” and “outside” may be used to indicate directions or positions as viewed in the drawings, and they are merely used to facilitate the description in the present disclosure, rather than to indicate or imply that a device or member must be arranged or operated at a specific position. In addition, such words as “first”, “second” and “third” may be merely used to differentiate different components rather than to indicate or imply any importance.

The above are the preferred embodiments of the present disclosure, but shall not be construed as limiting the scope of the present disclosure. A person skilled in the art may make various modifications, alterations or substitutions without departing from the spirit of the present disclosure, and these modifications, alterations or substitutions shall also fall within the scope of the present disclosure. Hence, the scope of the present disclosure shall be subject to the scope defined by the appended claims.

What is claimed is:

1. A computer-implemented sound calibration method, wherein an audio playback system comprises a subwoofer, a main speaker, and an audio collection device, wherein the computer-implemented sound calibration method comprises:
detecting connection states of the subwoofer and the main speaker and an operating state of the audio collection device, and determining whether the connection states and the operating state are normal;
in a case that the connection states and the operating state are normal, testing an acoustic characteristic of a scenario where the audio playback system is located and a delay at a primary listening position using a first test audio to obtain a frequency response curve and a propagation delay of the scenario, wherein the propagation delay is a time difference between propagation of the first test audio from the subwoofer to the primary listening position and propagation of the first test audio from the main speaker to the primary listening position;
controlling the subwoofer and the main speaker to play a second test audio, collecting a transmitted audio at the primary listening position through the audio collection device, and calculating a sound generation delay between the subwoofer and the main speaker using a cross correlation method;
calculating a volume parameter difference of the subwoofer relative to the main speaker based on the transmitted audio of the subwoofer and the transmitted audio of the main speaker; and
calibrating a device parameter of the subwoofer based on the sound generation delay, the volume parameter difference and the frequency response curve.

2. The computer-implemented sound calibration method according to claim 1, wherein the testing the acoustic characteristic of the scenario where the audio playback system is located and the delay at the primary listening position using the first test audio to obtain the frequency response curve and the propagation delay of the scenario comprises:
playing the first test audio at a position where the subwoofer is located and a position where the main speaker is located, and using third test audio through the audio collection device at the primary listening position in the scenario;
calculating the time difference between the propagation of the first test audio from the subwoofer to the primary listening position and the propagation of the first test audio from the main speaker to the primary listening position based on a receiving time of the third test audio and a sending time of the first test audio, to obtain a propagation time difference; and
analyzing spectra of the third test audio and the first test audio through a fast Fourier transform algorithm, and calculating a corresponding frequency response based on analyzed spectra to obtain the frequency response curve of the scenario.

3. The computer-implemented sound calibration method according to claim 1, wherein the controlling the subwoofer and the main speaker to play the second test audio, collecting the transmitted audio at the primary listening position through the audio collection device, and calculating the sound generation delay between the subwoofer and the main speaker using the cross correlation method comprises:
allowing the subwoofer to generate a first sound signal based on the second test audio, and collecting the first sound signal at the primary listening position through the audio collection device;
allowing the main speaker to generate a second sound signal based on the second test audio, and collecting the second sound signal at the primary listening position through the audio collection device; and
calculating a time difference between the first sound signal and the second sound signal using the cross correlation method to obtain the sound generation delay between the subwoofer and the main speaker.

4. The computer-implemented sound calibration method according to claim 3, wherein the calculating the volume parameter difference of the subwoofer relative to the main speaker based on the transmitted audio of the subwoofer and the transmitted audio of the main speaker comprises:
analyzing sound pressure level data of the first sound signal and sound pressure level data of the second sound signal;
determining whether the sound pressure level data of the first sound signal matches with the sound pressure level data of the second sound signal;
in a case that the sound pressure level data of the first sound signal does not match with the sound pressure level data of the second sound signal, calculating a difference between the sound pressure level data of the first sound signal and the sound pressure level data of the second sound signal, and inquiring a configuration parameter of the subwoofer in a predetermined correspondence table of sound pressures and volumes; and
calculating the volume parameter difference of the subwoofer relative to the main speaker based on the configuration parameter.

5. The computer-implemented sound calibration method according to claim 1, wherein the calibrating the device parameter of the subwoofer based on the sound generation delay, the volume parameter difference and the frequency response curve comprises:
determining whether the propagation delay is greater than a predetermined delay threshold;
performing compensation processing on a sound generation time of the subwoofer using the sound generation delay or both the propagation delay and the sound generation delay based on a determination result; and
calculating a compensation device parameter of the subwoofer based on the volume parameter difference and the frequency response curve, and performing calibration based on the compensation device parameter.

6. The computer-implemented sound calibration method according to claim 5, wherein the performing the compensation processing on the sound generation time of the subwoofer using the sound generation delay or both the propagation delay and the sound generation delay based on the determination result comprises:
determining whether the sound generation delay is greater than zero;
in a case that the propagation delay is greater than the predetermined delay threshold and the sound generation delay is greater than zero, performing delay processing on the subwoofer based on the propagation delay and the sound generation delay;
in a case that the propagation delay is greater than the predetermined delay threshold and the sound generation delay is smaller than zero, performing advancing processing on the subwoofer based on the propagation delay and the sound generation delay;
in a case that the propagation delay is smaller than the predetermined delay threshold and the sound generation delay is greater than zero, performing the delay processing on the subwoofer based on the sound generation delay; and
in a case that the propagation delay is smaller than the predetermined delay threshold and the sound generation delay is smaller than zero, performing the advancing processing on the subwoofer based on the sound generation delay.

7. The computer-implemented sound calibration method according to claim 5, wherein the performing the compensation processing on the sound generation time of the subwoofer using the sound generation delay or both the propagation delay and the sound generation delay based on the determination result further comprises:
analyzing phase responses of the main speaker and the subwoofer in a vicinity of a crossover frequency based on the transmitted audio; and
calculating a difference between the phase responses of the main speaker and the subwoofer, and delaying the sound generation time of the subwoofer by a predetermined fine-tuning value based on the difference, so that the subwoofer and the main speaker have a same phase within a same frequency range.

8. The computer-implemented sound calibration method according to claim 5, wherein the calculating the compensation device parameter of the subwoofer based on the volume parameter difference and the frequency response curve, and performing the calibration based on the compensation device parameter comprises:
calculating an audio gain of the subwoofer using a bisection method based on the volume parameter difference;
fitting the frequency response curve with the transmitted audio of the subwoofer using a least square method, to obtain an actual frequency response of the subwoofer; and
calculating the compensation device parameter of the subwoofer based on the audio gain and the actual frequency response, and performing the calibration.

9. The computer-implemented sound calibration method according to claim 1, wherein subsequent to calibrating the device parameter of the subwoofer based on the sound generation delay, the volume parameter difference and the frequency response curve, the computer-implemented sound calibration method further comprises:
adjusting the audio collection device to a plurality of secondary listening positions, and calculating a corresponding sound generation delay and a corresponding volume parameter difference; and
fusing the corresponding sound generation delay and the corresponding volume parameter difference at each of the plurality of secondary listening positions using a weighted mean method to obtain a fused compensation parameter, and calibrating the subwoofer.

10. The computer-implemented sound calibration method according to claim 9, wherein the fusing the corresponding sound generation delay and the corresponding volume parameter difference at each of the plurality of secondary listening positions using the weighted mean method to obtain the fused compensation parameter, and calibrating the subwoofer comprises:
measuring a distance between each of the plurality of secondary listening positions and the primary listening position, and assigning a corresponding weight value to the distance using the weighted mean method; and
fusing the corresponding sound generation delay and the corresponding volume parameter difference at each of the plurality of secondary listening positions based on the corresponding weight value to obtain the fused compensation parameter, and calibrating the subwoofer.

11. The computer-implemented sound calibration method according to claim 10, wherein subsequent to measuring the distance between each of the plurality of secondary listening positions and the primary listening positioning, the computer-implemented sound calibration method further comprises:
obtaining a frequency response curve at each of the plurality of secondary listening positions, and calculating a standard deviation of each of the plurality of secondary listening positions and the primary listening position; and
determining a spatial equalization degree of the scenario based on the standard deviation.

12. The computer-implemented sound calibration method according to claim 11, wherein the assigning the corresponding weight value to the distance using the weighted mean method comprises:
calculating the corresponding weight value at each of the plurality of secondary listening positions using the weighted mean method based on the spatial equalization degree and the distance.

13. An audio playback system, comprising a subwoofer, a main speaker, an audio collection device, a memory, and at least one processor, wherein the memory is configured to store therein an instruction;
the at least one processor is configured to call the instruction in the memory, so that the at least one processor performs steps of:
detecting connection states of the subwoofer and the main speaker and an operating state of the audio collection device, and determining whether the connection states and the operating state are normal;
in a case that the connection states and the operating state are normal, testing an acoustic characteristic of a scenario where the audio playback system is located and a delay at a primary listening position using a first test audio to obtain a frequency response curve and a propagation delay of the scenario, wherein the propagation delay is a time difference between propagation of the first test audio from the subwoofer to the primary listening position and propagation of the first test audio from the main speaker to the primary listening position;
controlling the subwoofer and the main speaker to play a second test audio, collecting a transmitted audio at the primary listening position through the audio collection device, and calculating a sound generation delay between the subwoofer and the main speaker using a cross correlation method;
calculating a volume parameter difference of the subwoofer relative to the main speaker based on the transmitted audio of the subwoofer and the transmitted audio of the main speaker; and
calibrating a device parameter of the subwoofer based on the sound generation delay, the volume parameter difference and the frequency response curve.

14. The audio playback system according to claim 13, wherein in a case of testing the acoustic characteristic of the scenario where the audio playback system is located and the delay at the primary listening position using the first test audio to obtain the frequency response curve and the propagation delay of the scenario, the at least one processor is configured to:
play the first test audio at a position where the subwoofer is located and a position where the main speaker is located, and use a third test audio through the audio collection device at the primary listening position in the scenario;
calculate the time difference between the propagation of the first test audio from the subwoofer to the primary listening position and the propagation of the first test audio from the main speaker to the primary listening position based on a receiving time of the third test audio and a sending time of the first test audio, to obtain a propagation time difference; and
analyze spectra of the third test audio and the first test audio through a fast Fourier transform algorithm, and calculate a corresponding frequency response based on analyzed spectra to obtain the frequency response curve of the scenario.

15. The audio playback system according to claim 13, wherein in a case of controlling the subwoofer and the main speaker to play the second test audio, collecting the transmitted audio at the primary listening position through the audio collection device, and calculating the sound generation delay between the subwoofer and the main speaker using the cross correlation method, the at least one processor is configured to:
allow the subwoofer to generate a first sound signal based on the second test audio, and collect the first sound signal at the primary listening position through the audio collection device;
allow the main speaker to generate a second sound signal based on the second test audio, and collect the second sound signal at the primary listening position through the audio collection device; and
calculate a time difference between the first sound signal and the second sound signal using the cross correlation method to obtain the sound generation delay between the subwoofer and the main speaker.

16. The audio playback system according to claim 15, wherein in a case of calculating the volume parameter difference of the subwoofer relative to the main speaker based on the transmitted audio of the subwoofer and the transmitted audio of the main speaker, the at least one processor is configured to:
analyze sound pressure level data of the first sound signal and sound pressure level data of the second sound signal;
determine whether the sound pressure level data of the first sound signal matches with the sound pressure level data of the second sound signal;
in a case that the sound pressure level data of the first sound signal does not match with the sound pressure level data of the second sound signal, calculate a difference between the sound pressure level data of the first sound signal and the sound pressure level data of the second sound signal, and inquire a configuration parameter of the subwoofer in a predetermined correspondence table of sound pressures and volumes; and
calculate the volume parameter difference of the subwoofer relative to the main speaker based on the configuration parameter.

17. The audio playback system according to claim 13, wherein in a case of calibrating the device parameter of the subwoofer based on the sound generation delay, the volume parameter difference and the frequency response curve, the at least one processor is configured to:
determine whether the propagation delay is greater than a predetermined delay threshold;
perform compensation processing on a sound generation time of the subwoofer using the sound generation delay or both the propagation delay and the sound generation delay based on a determination result; and
calculate a compensation device parameter of the subwoofer based on the volume parameter difference and the frequency response curve, and perform calibration based on the compensation device parameter.

18. The audio playback system according to claim 17, wherein in a case of performing the compensation processing on the sound generation time of the subwoofer using the sound generation delay or both the propagation delay and the sound generation delay based on the determination result, the at least one processor is configured to:
determine whether the sound generation delay is greater than zero;
in a case that the propagation delay is greater than the predetermined delay threshold and the sound generation delay is greater than zero, perform delay processing on the subwoofer based on the propagation delay and the sound generation delay;
in a case that the propagation delay is greater than the predetermined delay threshold and the sound generation delay is smaller than zero, perform advancing processing on the subwoofer based on the propagation delay and the sound generation delay;
in a case that the propagation delay is smaller than the predetermined delay threshold and the sound generation delay is greater than zero, perform the delay processing on the subwoofer based on the sound generation delay; and
in a case that the propagation delay is smaller than the predetermined delay threshold and the sound generation delay is smaller than zero, perform the advancing processing on the subwoofer based on the sound generation delay.

19. The audio playback system according to claim 17, wherein in a case of performing the compensation processing on the sound generation time of the subwoofer using the sound generation delay or both the propagation delay and the sound generation delay based on the determination result, the at least one processor is further configured to:
analyze phase responses of the main speaker and the subwoofer in a vicinity of a crossover frequency based on the transmitted audio; and
calculate a difference between the phase responses of the main speaker and the subwoofer, and delay the sound generation time of the subwoofer by a predetermined fine-tuning value based on the difference, so that the subwoofer and the main speaker have a same phase within a same frequency range.

20. A computer-readable storage medium storing therein a computer-executable instruction, wherein the computer-executable instruction is called and executed by a processor to:
detect connection states of a subwoofer and a main speaker and an operating state of an audio collection device, and determine whether the connection states and the operating state are normal;
in a case that the connection states and the operating state are normal, test an acoustic characteristic of a scenario where an audio playback system is located and a delay at a primary listening position using a first test audio to obtain a frequency response curve and a propagation delay of the scenario, wherein the propagation delay is a time difference between propagation of the first test audio from the subwoofer to the primary listening position and propagation of the first test audio from the main speaker to the primary listening position;
control the subwoofer and the main speaker to play a second test audio, collect a transmitted audio at the primary listening position through the audio collection device, and calculate a sound generation delay between the subwoofer and the main speaker using a cross correlation method;
calculate a volume parameter difference of the subwoofer relative to the main speaker based on the transmitted audio of the subwoofer and the transmitted audio of the main speaker; and
calibrate a device parameter of the subwoofer based on the sound generation delay, the volume parameter difference and the frequency response curve.
